(19) United States
(12) Patent Application Publication
(10) Pub. No.: US 2024/0047847 A1
(43) Pub. Date: Feb. 8, 2024

(54) ANTENNA DEVICE

(71) Applicant: KYOCERA Corporation, Kyoto-shi, Kyoto (JP)

(72) Inventors: Yoshihide OKAWA, Kirishima-shi (JP); Sentarou YAMAMOTO, Kagoshima-shi (JP)

(73) Assignee: KYOCERA Corporation, Kyoto-shi, Kyoto (JP)

(21) Appl. No.: 18/267,594

(22) PCT Filed: Dec. 10, 2021
(86) PCT No.: PCT/JP2021/045614

§ 371 Date: Jun. 15, 2023

(30) Foreign Application Priority Data
Dec. 28, 2020 (JP) 2020-219127

(51) Int. Cl. H01Q 1/12; H01Q 1/02

(52) U.S. Cl. CPC H01Q 1/12; H01Q 1/02

(57) ABSTRACT

An antenna device includes an antenna, a first base member, a second base member, a support, and a first fixing member. The antenna, the first base member, the second base member, and the support are arrayed in this order. The first base member and the second base member are spaced apart from each other and coupled via the first fixing member.

### CROSS-REFERENCE TO RELATED APPLICATIONS

This application is a national stage application of International Application No. PCT/JP2021/045614, filed on Dec. 10, 2021, which designates the United States, incorporated herein by reference, and which claims the benefit of priority from Japanese Patent Application No. 2020-219127, filed Dec. 218, 2020, the entire contents of which are incorporated herein by reference.

### TECHNICAL FIELD

An embodiment of the disclosure relates to an antenna device.

### BACKGROUND OF INVENTION

Conventionally, a structure in which an antenna is mounted on a substrate has been disclosed.

### CITATION LIST

### Patent Literature

Patent Document 1: WO 2018/168391 A1

### SUMMARY

An aspect of an embodiment provides an antenna device including an antenna, a first base member, a second base member, a support, and a first fixing member. The antenna, the first base member, the second base member, and the support are arrayed in this order. The first base member and the second base member are spaced apart from each other and coupled via the first fixing member.

### BRIEF DESCRIPTION OF THE DRAWINGS

FIG. 1 is a perspective view illustrating an antenna device body according to an embodiment.

FIG. 2 is a cross-sectional view schematically illustrating an antenna device according to the embodiment.

FIG. 3 is a plan view schematically illustrating an antenna of the antenna device according to the embodiment.

FIG. 4 is a cross-sectional view taken along IV-IV in FIG. 3.

FIG. 5 is a cross-sectional view schematically illustrating the antenna device according to a first variation of the embodiment.

FIG. 6 is a cross-sectional view schematically illustrating the antenna device according to a second variation of the embodiment.

FIG. 7 is a cross-sectional view schematically illustrating the antenna device according to a third variation of the embodiment.

FIG. 8 is a perspective view illustrating an antenna device body according to another aspect of the embodiment.

FIG. 9 is a cross-sectional view schematically illustrating an antenna device including the antenna device body illustrated in FIG. 8.

FIG. 10 is a cross-sectional view schematically illustrating the antenna device according to another aspect of the embodiment.

FIG. 11 is a perspective view illustrating an antenna device body according to another aspect of the embodiment.

### DESCRIPTION OF EMBODIMENTS

An embodiment of an antenna device disclosed in the present application will be described in detail below. The present invention is not limited by the following embodiments.

### Embodiment

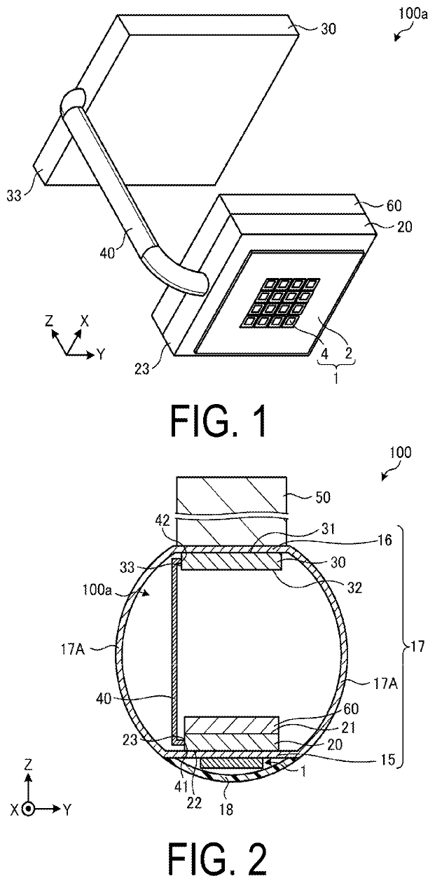

The configuration of an antenna device according to an embodiment will be described with reference to FIGS. 1 and 2. FIG. 1 is a perspective view illustrating an antenna device body according to an embodiment. FIG. 2 is a cross-sectional view schematically illustrating an antenna device according to the embodiment.

As illustrated in FIG. 2, an antenna device 100 includes an antenna 1, a casing 17, a radome 18, a first base member 20, a second base member 30, a first fixing member 40, and a support 50. The antenna device 100 includes an antenna device body 100a, the casing 17, and the support 50.

The antenna device body 100a illustrated in FIG. 1 includes the antenna 1, the first base member 20, the second base member 30, and the first fixing member 40.

The antenna 1 includes a first substrate 2 and a second substrate 4. In FIG. 2, the antenna 1 and components located in the vicinity of the antenna 1 are not illustrated. The antenna 1 will be described in detail later.

For the sake of clarity, FIGS. 1 and 2 illustrate a three-dimensional orthogonal coordinate system with an X axis and a Y axis corresponding to directions in which a plurality of second substrates 4 are arrayed and a Z axis corresponding to a direction intersecting an XY plane. Such an orthogonal coordinate system is also presented in the other drawings used in the description below. In the following description, the positive side in the Z-axis direction may be referred to as “above”, and the negative side in the Z-axis direction side may be referred to as “below”, for convenience. The same and/or similar components as those of the antenna device body 100a illustrated in FIG. 1 and the antenna device 100 illustrated in FIG. 2 are denoted by the same reference signs, and descriptions thereof will be omitted or simplified.

The casing 17 includes a first support member 15, a second support member 16, and a curved support portion 17A. The casing 17 has a substantially spherical outer surface. The curved support portion 17A has a circular shape when the sphere is cut along the XY plane.

The first support member 15 illustrated in FIG. 2 is a flat portion of the casing 17 that is in contact with the antenna 1 and the first base member 20. The second support member 16 is a flat portion of the casing 17 that is in contact with the second base member 30 and the support 50. The curved support portion 17A is a portion of the casing 17 other than the first support member 15 and the second support member 16.

The material of the first support member 15 and the second support member 16 may be, for example, a metal such as copper. The material of a portion (curved support portion 17A) of the casing 17 other than the first support member 15 and the second support member 16 may be, for example, a metal such as aluminum or an aluminum alloy.

The first support member 15 and the second support member 16 are located at both ends of the casing 17 in the height direction (Z-axis direction). The antenna 1 and the first base member 20 are mounted on the first support member 15 located on the negative side in the Z-axis direction, of the first support member 15 and the second support member 16. The second base member 30 and the support 50 are mounted on the second support member 16 located at an end portion of the casing 17 on the positive side in the Z-axis direction.

The radome 18 protrudes in a spherical crown shape from the first support member 15 toward the negative side in the Z-axis direction. The radome 18 is made of a material such as polytetrafluoroethylene that covers a conductor portion 5 (see FIG. 4) of the antenna 1, which will be described later, and does not suppress transmission of radio waves emitted from the antenna 1.

Here, the radius of curvature of the casing 17 (curved support portion 17A) and the radius of curvature of the radome 18 are preferably equal. When the radius of curvature of the casing 17 (curved support portion 17A) and the radius of curvature of the radome 18 are equal, there is no protruding portion, no sharply curved portion, or no recessed portion on the outer surfaces of the casing 17 and the radome 18. Therefore, the casing 17 and the radome 18 have high resistance to external pressure such as an external impact. This increases the durability of the casing 17.

The first base member 20 is located between the antenna 1 and the second base member 30. The first base member 20 has a first surface 21 facing the second base member 30 and a second surface 22 facing the antenna 1.

The first base member 20 is located above (on the positive side in the Z-axis direction) the first support member 15. When the ground surface is defined as a reference plane, the antenna 1 is located below the first base member 20 with the first support member 15 interposed therebetween. Since the antenna 1 is located below the first base member 20, heat generated in the antenna 1 is easily transmitted to the first base member 20, for example, due to the convection effect caused by the property that heat tends to ascend as the temperature becomes higher. Therefore, the first base member 20 can efficiently dissipate heat generated in the antenna 1, thereby improving the heat dissipation property of the antenna device 100.

The first base member 20 has a first end surface 23 located at an end portion on the negative side in the Y-axis direction (first direction). The first fixing member 40 is fixed to the first end surface 23. The first end surface 23 is indicated as an example of an end surface of the first base member 20.

The second base member 30 is located between the first base member 20 and the support 50. The second base member 30 has a third surface 31 facing the support 50 and a fourth surface 32 facing the first base member 20. The first surface 21 of the first base member 20 and the fourth surface 32 of the second base member 30 are configured to face each other.

The second base member 30 is located below (on the negative side in the Z-axis direction) the second support member 16. When the second base member 30 is located below the support 50, heat transferred from the antenna 1 side to the second base member 30 via the first fixing member 40 and the space in the casing 17 is easily transmitted to the support 50, for example, and can be efficiently dissipated. Therefore, the heat dissipation property of the antenna device 100 can be improved.

The second base member 30 has a second end surface 33 located at an end portion on the negative side in the Y-axis direction (first direction). The first fixing member 40 is fixed to the second end surface 33. Of the two end portions of the first fixing member 40, the end portion on the opposite side to the end portion coupled to the first base member 20 is coupled to the second base member 30. Of the two end portions of the first fixing member 40, the end portion coupled to the first base member 20 is referred to as a first end portion 41. Of the two end portions of the first fixing member 40, the end portion coupled to the second base member 30 is referred to as a second end portion 42. The second end surface 33 is indicated as an example of an end surface of the second base member 30.

The first surface 21 of the first base member 20 facing the fourth surface 32 of the second base member 30 is located away from the fourth surface 32 of the second base member 30 facing the first surface 21. Accordingly, the first base member 20 and the second base member 30 dissipate heat by, for example, outside air moving between the first base member 20 and the second base member 30. The first base member 20 and the second base member 30 may be made of metal such as copper, for example.

The first fixing member 40 is located between the first base member 20 and the second base member 30, and bridges the first base member 20 and the second base member 30. In other words, the first base member 20 and the second base member 30 are coupled via the first fixing member 40.

The first fixing member 40 is a solid rod-shaped body, for example. The first fixing member 40 includes the first end portion 41 and the second end portion 42 as described above. The first end portion 41 is connected to the first end surface 23 of the first base member 20. The second end portion 42 is connected to the second end surface 33 of the second base member 30.

The first fixing member 40 has a positioning function of causing the first surface 21 of the first base member 20 and the fourth surface 32 of the second base member 30 to face each other with a predetermined interval therebetween and contributes to heat dissipation. For example, heat generated on the first base member 20 side is transferred to the second base member 30 via the first fixing member 40. When the first fixing member 40 is fixed so as to bridge the first base member 20 and the second base member 30 which are positioned away from each other in this way, heat generated in the antenna 1 can be efficiently dissipated. Consequently, the heat dissipation property of the antenna device body 100a can be improved. The first fixing member 40 may be, for example, made of a metal such as copper.

The support 50 is located above (on the positive side in the Z-axis direction) the second support member 16. The support 50 has a quadrangular prism shape elongated in the Z-axis direction, for example. The support 50 may be, for example, a member made of a metal such as an aluminum alloy or the like. A plurality of through holes extending in the Z-axis direction may be provided inside the support 50 to enhance the heat dissipation property of the antenna device 100. A fin member (not illustrated) may be provided to protrude to the outside of the support 50.

The antenna device 100 may include a power supply unit 60. The power supply unit 60 supplies power to the antenna 1. The power supply unit 60 converts electrical power output from an external power supply (not illustrated) to a predetermined electrical power value as necessary and supplies the converted power to the antenna 1. The power supply unit 60 is located on the first surface 21 of the first base member 20, for example. By positioning the power supply unit 60 so as to be in contact with the first surface 21 of the first base member 20 in this way, heat generated in the power supply unit 60 can be efficiently dissipated due to power supply, and thus the heat dissipation property of the antenna device 100 can be improved.

When the ground surface is defined as a reference plane and the positive side in the Z-axis direction is defined as the sky side, the support 50 is located above the second support member 16 in the antenna device 100 illustrated in FIG. 2. Accordingly, the antenna 1 is located below the support 50. By using the antenna device 100 with the antenna 1 located below the support 50 in this way, the heat dissipation property of the antenna 1 can be enhanced.

Antenna

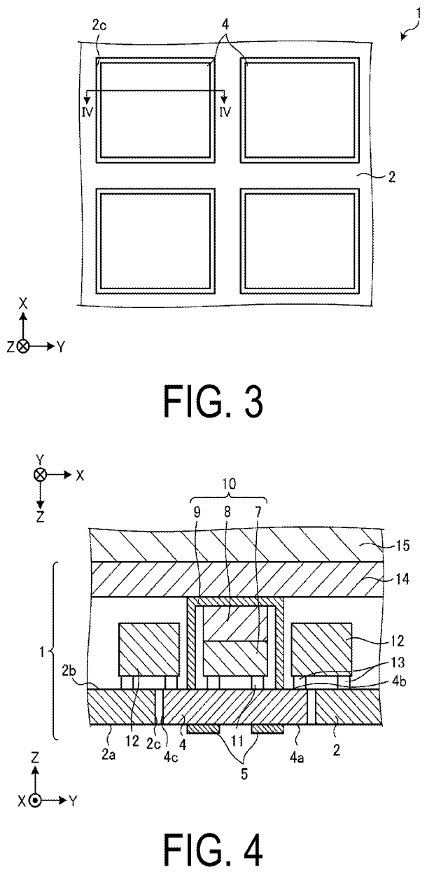

An example of the antenna 1 will be described with reference to FIGS. 3 and 4. FIG. 3 is a plan view schematically illustrating an antenna of the antenna device according to the embodiment. FIG. 4 is a cross-sectional view taken along IV-IV in FIG. 3.

As illustrated in FIGS. 3 and 4, the antenna 1 includes a first substrate 2, a second substrate 4, a conductor portion 5, and an element portion 10.

Here, each surface of the first substrate 2 and the second substrate 4 illustrated in FIG. 4 is defined as follows. The main surface of the first substrate 2 on the negative side in the Z-axis direction (downward) is defined as a fifth surface 2a. The main surface of the first substrate 2 on the positive side in the Z-axis direction (upward) is defined as a sixth surface 2b. The main surface of the second substrate 4 on the negative side in the Z-axis direction (downward) is defined as a seventh surface 4a. The main surface of the second substrate 4 on the positive side in the Z-axis direction (upward) is defined as an eighth surface 4b.

The first substrate 2 has a plurality of through holes 2c penetrating in the thickness direction (Z-axis direction). The through holes 2c have a quadrangular prismatic shape, for example, and open in the fifth surface 2a and the sixth surface 2b located at the two ends of the first substrate 2 in the thickness direction (Z-axis direction). Here, the first substrate 2 may have a through hole 2c having a depth less than the length of the side having the smallest length among the sides of the through hole 2c, and even in such a case, the through hole 2c may be referred to as a through hole 2c in a quadrangular prism shape. The same applies to a through hole 2c having a hexagonal prism shape or the like indicated as a structure other than the quadrangular prism shape. The side of the through hole 2c is one side of a quadrangular shape when the shape of the through hole 2c when the first substrate 2 is viewed in plan view in the Z-axis direction is a quadrilateral shape as described above. The sides of the through hole 2c are sides of opening portions extending along the fifth surface 2a and the sixth surface 2b of the first substrate 2. Surfaces of the first substrate 2 extending from the opening portion of the fifth surface 2a to the opening portion of the sixth surface 2b are defined as inner walls.

The plurality of through holes 2c are arranged at predetermined intervals along the X axis and the Y axis intersecting the X axis. The shape of the through hole 2c is not limited to a quadrangular prism shape, and may be, for example, a hexagonal prism shape, an octagonal prism shape, or another prism shape, or may be any column shape such as a circular column shape or an elliptical column shape. The plurality of through holes 2c of the first substrate 2 may be arrayed in a rectangular lattice as illustrated in FIG. 3, or may be arrayed in any manner such as an orthorhombic lattice, a triangular lattice, or a hexagonal lattice, for example. The plurality of through holes 2c may be arranged irregularly.

The second substrate 4 is located so as to be fitted into the through hole 2c of the first substrate 2. The second substrate 4 has a quadrangular prism shape, and has the seventh surface 4a and the eighth surface 4b located at both ends of the second substrate 4 in the thickness direction (Z-axis direction), and a side surface 4c located between the seventh surface 4a and the eighth surface 4b. The side surface 4c of the second substrate 4 is located to face the wall surface of the through hole 2c.

The second substrate 4 has a quadrilateral shape when viewed in plan view. The second substrate 4 has a predetermined thickness in the Z-axis direction. When the thickness of the second substrate 4 is smaller than the length of the shortest side among the sides of the second substrate 4, the second substrate 4 may be a flat plate having a quadrilateral shape (or a rectangular shape) when viewed in plan view. While FIG. 3 illustrates the shape of the second substrate 4 when viewed in plan view, the second substrate 4 may be shaped to have rounded corners. Other shapes such as a hexagonal prism shape described below may also have rounded corners.

The side surface 4c of the second substrate 4 is located to face the through hole 2c across a gap. In other words, the side surface 4c of the second substrate 4 is located away from the wall surface of the through hole 2c. When the first substrate 2 and the second substrate 4 are located away from each other in this manner, air can flow through the gap between the first substrate 2 and the second substrate 4. Therefore, heat generated in the antenna 1 can be efficiently dissipated, and thus the heat dissipation property of the antenna device 100 can be improved. Here, the interval between the side surface 4c of the second substrate 4 and the through hole 2c may be, for example, about 0.5 mm.

The first substrate 2 and the second substrate 4 are, for example, wiring boards. The first substrate 2 and the second substrate 4 may be, for example, multilayer wiring boards which are located along the XY plane and in which layers each including an organic resin as an insulating layer are layered in the Z-axis direction. The second substrate 4 may be, for example, a dielectric substrate containing a dielectric material. The second substrate 4 may be an AIP (Antenna In Package). The thicknesses of the first substrate 2 and the second substrate 4 may be equal or different.

The second substrate 4 is fixed to the first substrate 2. Examples of the method of fixing the second substrate 4 to the first substrate 2 include a method in which a plate is attached to the fifth surface 2a of the first substrate 2 so as to protrude into the through hole 2c.

The shape of the second substrate 4 is not limited to a quadrangular prism shape, and may be, for example, a hexagonal prism shape, an octagonal prism shape, or another prism shape, a circular column shape, or an elliptical prism shape. The second substrate 4 may be located such that the side surface 4c and the through hole 2c are equally spaced over the entire second substrate 4. The second substrate 4 may be located such that the interval in the X-axis direction and the interval in the Y-axis direction are different from each other, for example.

The conductor portion 5 is located on the seventh surface 4a of the second substrate 4. The conductor portion 5 is a patch, for example, and may be an electrical conductor film made of an electrically conductive material such as copper, for example. The conductor portion 5 may include, for example, copper, a copper foil, or copper plating as the conductor material.

As illustrated in FIG. 4, when the antenna device 100 is actually used, the conductor portion 5 is located below a circuit unit 7, which will be described later, of the element portion 10. Heat generated in the conductor portion 5 is dissipated as air flows through the gap between the first substrate 2 and the second substrate 4. In this manner, the heat transport capacity of the antenna device 100 can be enhanced.

The element portion 10 is mounted on the eighth surface 4b of the second substrate 4. The element portion 10 includes the circuit unit 7, a first heat dissipation body 8, and a heat dissipation member 9.

The circuit unit 7 is, for example, an integrated circuit. The circuit unit 7 may include, for example, an integrated circuit such as a radio frequency integrated circuit (RFIC). The circuit unit 7 is electrically connected to the second substrate 4 via a first connecting member 11 to be described later. The RFIC may be, for example, a high electron mobility transistor (HEMT) or a heterojunction bipolar transistor (HBT).

The first connecting member 11 is located on the eighth surface 4b of the second substrate 4. The first connecting member 11 has a predetermined height in the thickness direction of the second substrate 4, and connects the second substrate 4 and the circuit unit 7. The first connecting member 11 may be a bump in a columnar shape, for example. By positioning the first connecting member 11 between the second substrate 4 and the circuit unit 7, heat generated in the circuit unit 7 is more easily transmitted to the first heat dissipation body 8 than to the second substrate 4. Therefore, the heat dissipation property can be enhanced as compared with the case where the second substrate 4 and the circuit unit 7 are brought into contact with each other without interposing the first connecting member 11 therebetween. The first connecting member 11 is indicated as an example of a connecting member. The first connecting member 11 may be a so-called solder ball.

The first heat dissipation body 8 is located between the heat dissipation member 9 and the circuit unit 7. The first heat dissipation body 8 may be, for example, a thermal interface material (TIM). The first heat dissipation body 8 contains, for example, carbon. When the first heat dissipation body 8 contains carbon, the thermal conductivity can be increased as compared with the case where the first heat dissipation body 8 does not contain carbon. The first heat dissipation body 8 may contain, for example, an organic resin such as an epoxy resin or a silicone resin.

The surface of the first heat dissipation body 8 may have adhesive properties. When the surface of the first heat dissipation body 8 has adhesive properties, the circuit unit 7 and the heat dissipation member 9 can be bonded to each other without interposing, for example, an adhesive material or another member. The first heat dissipation body 8 may be located over the entire surface of the circuit unit 7 facing the heat dissipation member 9. When the first heat dissipation body 8 is located over the entire surface of the circuit unit 7 facing the heat dissipation member 9, the heat dissipation member 9 and the circuit unit 7 can be bonded to each other with no gap therebetween, thereby increasing the heat transfer surface area. This can enhance the heat transport capacity.

The first heat dissipation body 8 may have a layered structure. When the first heat dissipation body 8 is layered, organic resin films having different elastic moduli may be layered in the thickness direction (Z-axis direction), for example. For example, when using the first heat dissipation body 8 that has an adhesive surface facing the circuit unit 7 or the heat dissipation member 9 and that has a high-strength interior, for example, the first heat dissipation body 8 is less likely to be peeled off or damaged, and the antenna device 100 having a high strength can be obtained. In this case, the material of the surface of the first heat dissipation body 8 and the material of the inside thereof may have different constituents.

The heat dissipation member 9 accommodates the circuit unit 7. For example, the heat dissipation member 9 seals the circuit unit 7 between the heat dissipation member 9 and the second substrate 4, and suppresses exposure of the circuit unit 7. The heat dissipation member 9 may have, for example, a lid shape covering the periphery of the circuit unit 7. The heat dissipation member 9 may be, for example, a heat spreader configured to promote rapid heat dissipation from the circuit unit 7. The material of the heat dissipation member 9 may be, for example, an aluminum alloy or other metal. The material of the heat dissipation member 9 may be, for example, a resin such as a thermosetting resin or a photo-curable resin. The heat dissipation member 9 may be, for example, made of metal in consideration of mechanical strength, thermal resistance, and thermal conductivity.

The heat dissipation member 9 may have a single-layer structure, or may have a structure in which a metal plate and an organic resin film (organic resin plate) are layered, for example. The heat dissipation member 9 may be made of a metal on the outer side and an organic resin on the inner side in order to reduce sensitivity to the ambient temperature, for example.

The antenna 1 further includes an interposer 12 and a second heat dissipation body 14.

The interposer 12 connects the first substrate 2 and the second substrate 4. The interposer 12 is electrically connected to wiring included in each of the first substrate 2 and the second substrate 4 via a second connecting member 13 to be described later.

The second connecting member 13 is located on each of the sixth surface 2b of the first substrate 2 and the eighth surface 4b of the second substrate 4. The second connecting member 13 has a predetermined height in the thickness direction of the second substrate 4 and connects the first substrate 2 and the second substrate 4 to the interposer 12. The second connecting member 13 is indicated as an example of a connecting member. The second connecting member 13 may be a bump in a columnar shape, for example.

By positioning the second connecting member 13 between the first substrate 2 and the interposer 12 and between the second substrate 4 and the interposer 12, air can flow through the gap between the first substrate 2 and the second substrate 4. Therefore, according to the antenna device 100 of the embodiment, it is possible to efficiently dissipate heat generated in the antenna 1, in particular the conductor portion 5, and thus the heat dissipation property can be improved. The second connecting member 13 may be a so-called solder ball. The second connecting member 13 may have the same shape and/or material as the first connecting member 11, or may have a different shape and/or material from the first connecting member 11.

The second heat dissipation body 14 is located between the heat dissipation member 9 and the first support member 15. The second heat dissipation body 14 may be, for example, a thermal interface material (TIM). The material and characteristics of the second heat dissipation body 14 may be, for example, the same as those of the first heat dissipation body 8 described above.

The first support member 15 supports the antenna 1. The first support member 15 is fixed to the heat dissipation member 9 via the second heat dissipation body 14. The material of the first support member 15 may be, for example, a metal material such as copper or aluminum. The first support member 15 may be a part of the casing 17 (see FIG. 2).

First Variation

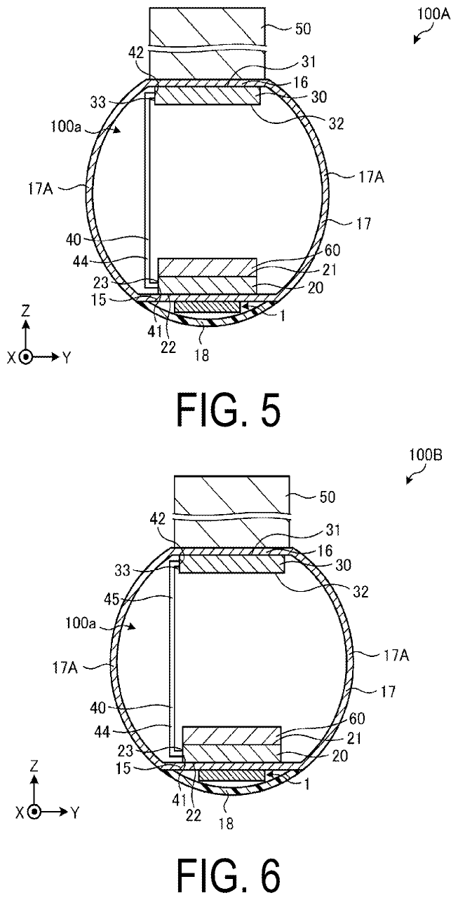

Variations of the antenna device 100 will be described with reference to FIGS. 5 to 11. FIG. 5 is a cross-sectional view schematically illustrating the antenna device according to a first variation of the embodiment.

In the antenna device body and the antenna device described below, the same reference signs are used for members arranged in the same manner as those of the above-described antenna device 100 for convenience.

As illustrated in FIG. 5, an antenna device 100A according to the first variation is different from the antenna device 100 according to the embodiment illustrated in FIG. 2 in that the first fixing member 40 has a hollow portion 44. The first fixing member 40 may be a tubular body having the hollow portion 44. Also when the first fixing member 40 is a tubular body having the hollow portion 44 as described above, the heat dissipation property of the antenna device 100A can be enhanced as compared with the case where the first fixing member 40 is not provided.

Second Variation

FIG. 6 is a cross-sectional view schematically illustrating

the antenna device according to a second variation of the embodiment. As illustrated in FIG. 6, an antenna device 100B according to the second variation is different from the antenna device 100A illustrated in FIG. 5 in that the first fixing member 40 is a heat pipe in which a cooling medium 45 is sealed in the hollow portion 44. The first fixing member 40 may be a tubular body having the hollow portion 44. The cooling medium 45 is vaporized when the first fixing member 40 is heated, and condensed when the first fixing member 40 is cooled. The material of the first fixing member 40 may be, for example, copper. The cooling medium 45 may be, for example, water or a CFC substitute (e.g., HFC-134 a). When the first fixing member 40 is a heat pipe as described above, the heat dissipation property of the antenna device 100B is further enhanced. When the first base member 20, which is more likely to have a high temperature than the second base member 30, is located below the second base member 30, upward movement of the cooling medium 45 due to vaporization and downward movement of the cooling medium 45 due to condensation are smoothly performed, and thus the heat transport capacity can be further enhanced.

Third Variation

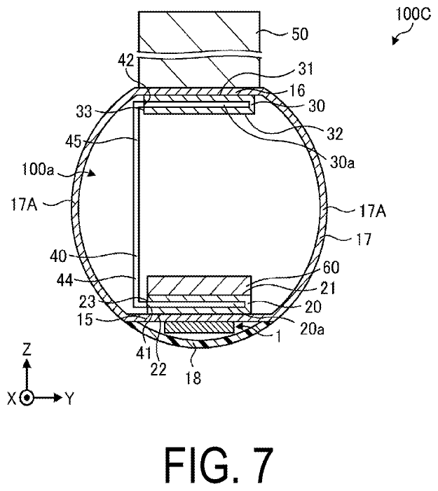

FIG. 7 is a cross-sectional view schematically illustrating the antenna device according to a third variation of the embodiment. As illustrated in FIG. 7, an antenna device 100C according to the third variation is different from the antenna device 100A illustrated in FIG. 5 in that the antenna device 100C has cavities 20a and 30a located inside the first base member 20 and the second base member 30, respectively. The cooling medium 45 flows through the cavities 20a and 30a. By allowing the cooling medium 45 to flow to the inside of the first base member 20 and the second base member 30 in this way, the heat dissipation property of the antenna device 100C is further enhanced.

While FIG. 7 illustrates an example in which the hollow portion 44 of the first fixing member 40 communicates with the cavities 20a and 30a, the configuration is not limited to this example. For example, the first end portion 41 and the second end portion 42 of the first fixing member 40 may be located inside the first base member 20 and the second base member 30, respectively. The cooling medium 45 may flow to the inside of only one of the first base member 20 and the second base member 30.

Fourth Variation

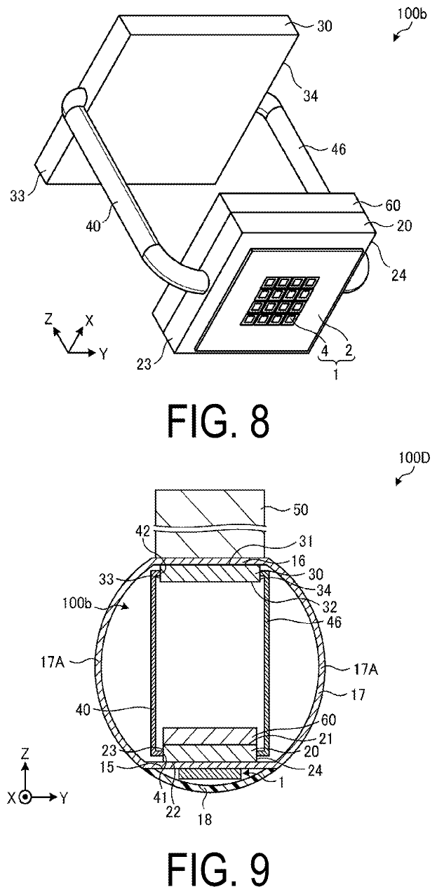

FIG. 8 is a perspective view illustrating an antenna device body according to another aspect of the embodiment. FIG. 9 is a cross-sectional view schematically illustrating an antenna device including the antenna device body illustrated in FIG. 8.

An antenna device body 100b illustrated in FIG. 8 and an antenna device 100D illustrated in FIG. 9 are different from the antenna device body 100a illustrated in FIG. 1 and the antenna device 100 illustrated in FIG. 2 in that a second fixing member 46 is further included. The second fixing member 46 is located between the third end surface 24 of the first base member 20 and the fourth end surface 34 of the second base member 30, and bridges the first base member 20 and the second base member 30.

The third end surface 24 is located at an end portion of the first base member 20 on the opposite side to the first end surface 23 along the Y-axis direction. The fourth end surface 34 is located at an end portion of the second base member 30 on the opposite side to the second end surface 33 along the Y-axis direction.

By providing the first fixing member 40 fixed to the first end surface 23 and the second end surface 33 and the second fixing member 46 fixed to the third end surface 24 and the fourth end surface 34 in this way, the heat dissipation path is increased as compared with the case where only the first fixing member 40 is provided. Accordingly, the heat dissipation property of the antenna device 100D can be further enhanced.

Fifth Variation

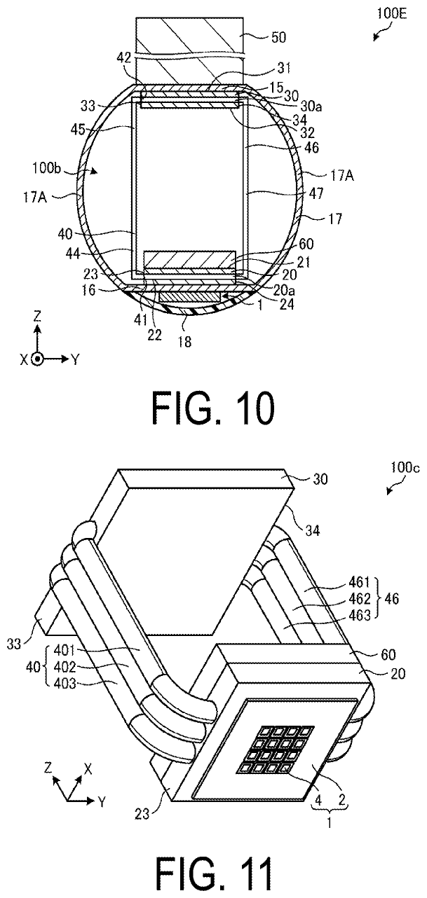

FIG. 10 is a cross-sectional view schematically illustrating the antenna device body according to another aspect of the embodiment. As illustrated in FIG. 10, an antenna device 100E is different from the antenna device body 100b illustrated in FIG. 8 and the antenna device 100D illustrated in FIG. 9 in that the first fixing member 40 and the second fixing member 46 are heat pipes.

Each of the first fixing member 40 and the second fixing member 46 may be a tubular body having a hollow portion 44, 47. Cavities 20a and 30a through which the cooling medium 45 flows, for example, may be located inside the first base member 20 and the second base member 30, respectively. The cavities 20a and 30a communicate with the hollow portions 44 and 47. The cooling medium 45 is sealed in an annular flow path constituted by the cavity 20a, the hollow portion 44, the cavity 30a, and the hollow portion 47. The cooling medium 45 can dissipate heat from the antenna device 100E by repeating vaporization and condensation according to the temperature of the members through which the cooling medium 45 flows. When the first base member 20, which is more likely to have a high temperature than the second base member 30, is located below the second base member 30, upward movement of the cooling medium 45 due to vaporization and downward movement of the cooling medium 45 due to condensation are smoothly performed, and thus the heat transport capacity can be further enhanced.

While FIG. 10 illustrates an example in which the hollow portions 44 and 47 of the first fixing member 40 and the second fixing member 46 communicate with the cavities 20a and 30a, the configuration is not limited to this example. For example, the first base member 20 and the second base member 30 may be located around heat pipes in which the cooling medium 45 is sealed in an annular hollow portion equivalent to the cavity 20a, the hollow portion 44, the cavity 30a, and the hollow portion 47.

Sixth Variation

FIG. 11 is a perspective view illustrating an antenna device body according to another aspect of the embodiment. As illustrated in FIG. 11, an antenna device body 100c is different from the antenna device body 100b illustrated in FIG. 8, the antenna device 100D illustrated in FIG. 9, and the antenna device 100E illustrated in FIG. 10 in that the first fixing member 40 and the second fixing member 46 each have a plurality of fixing members.

The first fixing member 40 constituting the antenna device body 100c includes a plurality of fixing members 401 to 403 arranged in parallel in the X-axis direction as a second direction intersecting the thickness direction (Z-axis direction) and the first direction (Y-axis direction). The second fixing member 46 includes a plurality of fixing members 461 to 463 arranged in parallel in the X-axis direction.

When the first fixing member 40 and the second fixing member 46 each include a plurality of fixing members in this way, the heat dissipation path is increased. Accordingly, the heat dissipation property of the antenna device including the antenna device body 100c can be further enhanced. The first fixing member 40 and the second fixing member 46 may be solid or hollow. The first fixing member 40 and the second fixing member 46 may be heat pipes in which the cooling medium 45 is sealed. The number of the fixing members 401 to 403 and the fixing members 461 to 463 illustrated in FIG. 11 is merely an example, and the number can be changed as necessary. The fixing members 401 to 403 and 461 to 463 may be spaced apart from each other to enhance the heat dissipation property. One of the first fixing member 40 and the second fixing member 46 may be a solid body and the other may be a heat pipe, for example.

The embodiment according to the present invention has been described above. However, the present invention is not limited to the embodiment described above, and various modifications can be made without departing from the essential spirit of the present invention.

### Experimental Example

The heat dissipation property of the antenna device illustrated in FIG. 10 was evaluated for a difference due to the presence or absence of the first fixing member 40 and the second fixing member 46.

The following materials were used for an antenna device according to an experimental example. The first substrate 2 had dimensions in both the X-axis direction and the Y-axis direction of 50 mm, and a thickness of 1 mm. The through hole 2c had dimensions in both the X-axis direction and the Y-axis direction of 5 mm. The second substrate 4 had dimensions in both the X-axis direction and the Y-axis direction of 4 mm, and a thickness of 1 mm. The interval between the side surface 4c of the second substrate 4 and the through hole 2c was 0.5 mm. The height of the interposer 12 from the sixth surface 2b of the first substrate 2 was 0.5 mm. The circuit unit 7 had dimensions in both the X-axis direction and the Y-axis direction of 2 mm. The supplied electrical power was 9 W. Both the first heat dissipation body 8 and the second heat dissipation body 14 had a thickness of 0.1 mm. Both the first support member 15 and the second support member 16 had a thickness of 2 mm.

The outer diameter of the casing 17 was 150 mm. Both the first base member 20 and the second base member 30 had a thickness of 10 mm. The height of the support 50 was 1 m.

The first substrate 2, the second substrate 4, and the interposer 12 had coefficients of thermal conductivity of 10 W/mK (X-axis direction and Y-axis direction) and 1 W/mK (Z-axis direction). The circuit unit 7, the first heat dissipation body 8, and the second heat dissipation body 14 had coefficients of thermal conductivity of 4.3 W/mK and 50 W/mK. The first support member 15, the second support member 16, the first base member 20, and the second base member 30 had a coefficient of thermal conductivity of 385 W/mK. The first fixing member 40 and the second fixing member 46 as heat pipes had a coefficient of thermal conductivity of 50000 W/mK. The configuration of the antenna device body 100b illustrated in FIG. 8 was used as a sample.

On the other hand, an antenna device according to a reference example was fabricated using the same materials as those of the antenna device body 100b according to the above-described experimental example except that the first fixing member 40 and the second fixing member 46 were not provided.

When the antenna devices according to the experimental example and the reference example were evaluated under the same energization conditions, it was found that the temperature at a location immediately below the conductor portion 5 was 100° C. or less in the antenna device according to the experimental example, and that the antenna device according to the experimental example had a heat dissipation property suitable for the intended use. On the other hand, the temperature at a location immediately below the conductor portion 5 exceeded 100° C. in the antenna device according to the reference example. Accordingly, it was found that the heat dissipation property was improved by positioning the first fixing member 40 and the second fixing member 46 between the first base member 20 and the second base member 30.

Further effects and variations can be readily derived by those skilled in the art. Thus, a wide variety of aspects of the present invention are not limited to the specific details and representative embodiments represented and described above. Accordingly, various changes are possible without departing from the spirit or scope of the general inventive concepts defined by the appended claims and their equivalents.

1. An antenna device comprising:
an antenna;
a first base member;
a second base member;
a support; and
a first fixing member, wherein
the antenna, the first base member, the second base member, and the support are arrayed in this order, and the first base member and the second base member are spaced apart from each other and coupled via the first fixing member.

2. The antenna device according to claim 1, wherein:
the first base member has a first surface facing the second base member, a second surface located opposite to the first surface, and a first end surface connected to each of the first surface and the second surface,
the second base member has a second end surface extending toward the first end surface, and
the first end surface and the second end surface are coupled by the first fixing member.

3. The antenna device according to claim 2, further comprising:
a second fixing member coupling the first base member and the second base member, wherein:
the first base member has a third end surface located on an opposite side to the first end surface;
the second base member has a fourth end surface located on an opposite side to the second end surface; and
the second fixing member is fixed to the third end surface and the fourth end surface.

4. The antenna device according to claim 3, wherein
at least one of the first fixing member and the second fixing member is a tubular body having a hollow portion.

5. The antenna device according to claim 4, wherein
at least one of the first fixing member and the second fixing member is a heat pipe comprising a cooling medium in the hollow portion.

6. The antenna device according to claim 5, wherein
at least one of the first base member and the second base member has a cavity through which the cooling medium flows.

7. The antenna device according to claim 3, wherein
at least one of the first fixing member and the second fixing member is constituted by a plurality of fixing members each coupling the first base member and the second base member.

8. The antenna device according to claim 1, wherein
the antenna is located below the support.

9. The antenna device according to claim 1, wherein
a power supply unit is located on a first surface of the first base member, the first surface facing the second base member.

10. The antenna device according to claim 1, wherein
the antenna is located on a second surface side opposite to a first surface of the first base member, the first surface facing the second base member.

11. The antenna device according to claim 1, wherein
the antenna is located below the first base member.
